(19) United States
(12) Patent Application Publication
(10) Pub. No.: US 2025/0294593 A1
(43) Pub. Date: Sep. 18, 2025

(54) SYSTEMS AND METHODS FOR DEVICE-TO-DEVICE COMMUNICATIONS

(71) Applicant: ZTE Corporation, Shenzhen (CN)

(72) Inventors: Weiqiang DU, Shenzhen (CN); Wei LUO, Shenzhen (CN); Lin CHEN, Shenzhen (CN)

(21) Appl. No.: 19/226,594

(22) Filed: Jun. 3, 2025

Related U.S. Application Data
(63) Continuation of application No. PCT/CN2023/086609, filed on Apr. 6, 2023.

(51) Int. Cl. H04W 72/25; H04L 1/1812; H04W 74/0808

(52) U.S. Cl. CPC H04W 72/25; H04L 1/1812; H04W 74/0808

(57) ABSTRACT

The present disclosure relates to determining, by a first wireless communication device, at least one first resource for performing Sidelink (SL) communications with a second wireless communication device; and performing, by the first wireless communication device with the second wireless communication device, the SL communications. The present disclosure relates to receiving, by a first wireless communication device from a second wireless communication device, Channel Occupy Time (COT) sharing information indicating sharing a COT of the second wireless communication device and determining, by the first wireless communication device, at least one resource for the COT. The second wireless communication device occupies the COT in response to performing a channel access procedure for a carrier.

### CROSS-REFERENCE TO RELATED APPLICATION

This application is a continuation and claims priority to International Application No. PCT/CN2023/086609, filed on Apr. 6, 2023, the disclosure of which is hereby incorporated by reference herein in its entirety.

### TECHNICAL FIELD

The disclosure relates generally to wireless communications and, more particularly, to device-to-device communications.

### BACKGROUND

Sidelink (SL) communication refers to wireless radio communication between two or more User Equipments (UEs). In this type of communications, two or more UEs that are geographically proximate to each other can communicate without being routed to a Network (e.g. Base Station (BS)) or a core network. Data transmissions in SL communications are thus different from typical cellular network communications that include transmitting data to a Network and receiving data from a Network. In SL communications, data is transmitted directly from a source UE to a target UE through, for example the Unified Air Interface (e.g., PC5 interface) without passing through a Network.

### SUMMARY

The example arrangements disclosed herein are directed to solving the issues relating to one or more of the problems presented in the prior art, as well as providing additional features that will become readily apparent by reference to the following detailed description when taken in conjunction with the accompany drawings. In accordance with various arrangements, example systems, methods, devices and computer program products are disclosed herein. It is understood, however, that these arrangements are presented by way of example and are not limiting, and it will be apparent to those of ordinary skill in the art who read the present disclosure that various modifications to the disclosed arrangements can be made while remaining within the scope of this disclosure.

Some arrangements of the present disclosure relate to systems, methods, apparatuses, and non-transitory computer-readable media relating to determine, by a first wireless communication device, at least one first resource for performing Sidelink (SL) communications with a second wireless communication device, and performing, by the first wireless communication device with the second wireless communication device, the SL communications.

Some arrangements of the present disclosure relate to systems, methods, apparatuses, and non-transitory computer-readable media relating to receiving, by a first wireless communication device from a second wireless communication device, Channel Occupy Time (COT) sharing information indicating sharing a COT of the second wireless communication device and determining, by the first wireless communication device, at least one resource for the COT. The second wireless communication device occupies the COT in response to performing a channel access procedure for a carrier.

The above and other aspects and their implementations are described in greater detail in the drawings, the descriptions, and the claims.

### BRIEF DESCRIPTION OF THE DRAWINGS

Various example arrangements of the present solution are described in detail below with reference to the following figures or drawings. The drawings are provided for purposes of illustration only and merely depict example arrangements of the present solution to facilitate the reader's understanding of the present solution. Therefore, the drawings should not be considered limiting of the breadth, scope, or applicability of the present solution. It should be noted that for clarity and ease of illustration, these drawings are not necessarily drawn to scale.

FIG. 1A is a diagram illustrating an example wireless communication network, according to various arrangements.

FIG. 1B is a diagram illustrating a block diagram of an example wireless communication system for transmitting and receiving downlink, uplink, and/or SL communication signals, according to various arrangements.

FIG. 2 illustrates an example scenario for SL communications, according to various arrangements.

FIG. 3 is a table illustrating values of Channel Access Priority Class (CAPC) and corresponding parameters related to the Channel Occupy Time (COT), according to various arrangements.

FIG. 4 is a table illustrating values of CAPC for uplink and corresponding parameters related to the COT, according to various arrangements.

FIG. 5 is a diagram illustrating Mode 2 resource selection, according to various arrangements.

FIG. 6 is a flowchart diagram illustrating an example method for performing resource selection and reselection for SL communications, according to various arrangements.

FIG. 7 is a flowchart diagram illustrating an example method for performing resource selection and reselection for SL communications, according to various arrangements.

FIG. 8 is a flowchart diagram illustrating an example method for performing COT sharing, according to various arrangements.

FIG. 9 is a diagram illustrating transmission resource pools of an initiating UE and a responding UE, according to various arrangements.

FIG. 10 is a flowchart diagram illustrating an example method for performing COT sharing, according to various arrangements.

FIG. 11 is a diagram illustrating frame structures of 15 kHz and 30 kHz Subcarrier Spacing (SCS), according to various arrangements.

FIG. 12 is a diagram illustrating example resources of the first and second modules, according to various arrangements.

FIG. 13 is a diagram illustrating resources of the first module and the resources of the second module, according to various arrangements.

FIG. 14 is a diagram illustrating example Multiple Consecutive Slot Transmission (MCSt) resources, according to various arrangements.

FIG. 15 is a table illustrating buffer size levels for a 5-bit buffer size field, according to various arrangements.

FIG. 16 is a diagram illustrating example MCSt resources, according to various arrangements.

FIG. 17 is a diagram illustrating example MCSt resources, according to various arrangements.

### DETAILED DESCRIPTION

Various example arrangements of the present solution are described below with reference to the accompanying figures to enable a person of ordinary skill in the art to make and use the present solution. As would be apparent to those of ordinary skill in the art, after reading the present disclosure, various changes or modifications to the examples described herein can be made without departing from the scope of the present solution. Thus, the present solution is not limited to the example arrangements and applications described and illustrated herein. Additionally, the specific order or hierarchy of steps in the methods disclosed herein are merely example approaches. Based upon design preferences, the specific order or hierarchy of steps of the disclosed methods or processes can be re-arranged while remaining within the scope of the present solution. Thus, those of ordinary skill in the art will understand that the methods and techniques disclosed herein present various steps or acts in a sample order, and the present solution is not limited to the specific order or hierarchy presented unless expressly stated otherwise.

With the advent of wireless multimedia services, users' demand for high data rate and user experience continue to increase, which sets forth higher requirements on the system capacity and coverage of traditional cellular networks. In addition, public safety, social networking, close-range data sharing, and local advertising have gradually expanded the need for Proximity Services, which allow users to understand and communicate with nearby users or objects. The traditional network-centric cellular networks have limited high data rate capabilities and support for proximity services. In this context, device-to-device (D2D) communications emerge to address the shortcomings of the network-centric models. The application of D2D technology can reduce the burden of cellular networks, reduce battery power consumption of UEs, increase data rate, and improve the robustness of network infrastructure, thus meeting the above-mentioned requirements of high data rate services and proximity services. D2D technology is also referred to as Proximity Services (ProSe), unilateral/sidechain/SL communication, and so on.

In some arrangements, wireless communications can be performed on carriers, frequency bands, and/or frequency spectrums. Some carriers are licensed carriers as they are licensed by a government or another authoritative entity to a service provider for exclusive use. Some carriers are unlicensed carriers, which are not licensed by any government or authoritative entities for exclusive use. Two or more service providers may operate in an unlicensed carrier. Currently, UEs may communicate directly with each other (e.g., without doing so using a base station) on the licensed carriers. No schemes have been provided for UEs to communicate with each other on unlicensed carriers.

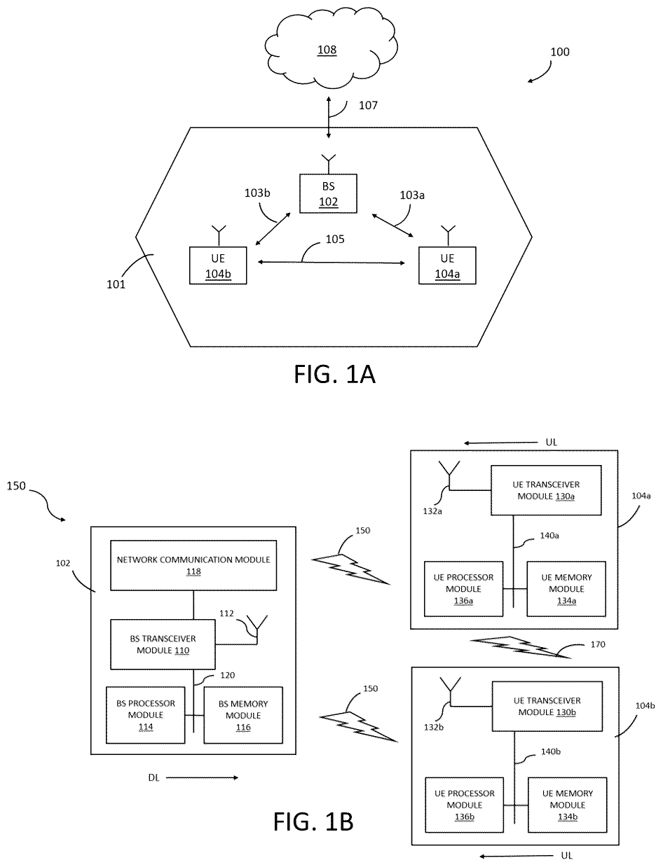

Referring to FIG. 1A, an example wireless communication network 100 is shown. The wireless communication network 100 illustrates a group communication within a cellular network. In a wireless communication system, a network side communication node or a Network can include a next Generation Node B (gNB), an E-UTRAN Node B (also known as Evolved Node B, eNodeB or eNB), a pico station, a femto station, a Transmission/Reception Point (TRP), an Access Point (AP), or so on. A terminal side node or a UE can include a device such as, for example, a mobile device, a smart phone, a cellular phone, a Personal Digital Assistant (PDA), a tablet, a laptop computer, a wearable device, a vehicle with a vehicular communication system, or so on. In FIG. 1A, a network side and a terminal side communication node are represented by a network 102 and UEs 104a and 104b, respectively. In some arrangements, the network 102 and UEs 104a/104b are sometimes referred to as “wireless communication node” and “wireless communication device,” respectively. Such communication nodes/devices can perform wireless communications.

In the illustrated arrangement of FIG. 1A, the network 102 can define a cell 101 in which the UEs 104a and 104b are located. The UEs 104a and/or 104b can be moving or remain stationary within a coverage of the cell 101. The UE 104a can communicate with the network 102 via a communication channel 103a. Similarly, the UE 104b can communicate with the network 102 via a communication channel 103b. In addition, the UEs 104a and 104b can communicate with each other via a communication channel 105. The communication channels 103a and 104b between a respective UE and the Network can be implemented using interfaces such as an Uu interface, which is also known as Universal Mobile Telecommunication System (UMTS) air interface. The communication channel 105 between the UEs is a SL communication channel and can be implemented using a PC5 interface, which is introduced to address high moving speed and high density applications such as, for example, D2D communications, Vehicle-to-Vehicle (V2V) communications, Vehicle-to-Pedestrian (V2P) communications, Vehicle-to-Infrastructure (V2I) communications, Vehicle-to-Network (V2N) communications, or the like. In some instances, vehicle network communications modes can be collective referred to as Vehicle-to-Everything (V2X) communications. The network 102 is connected to Core Network (CN) 108 through an external interface 107, e.g., an Iu interface.

In some examples, a remote UE (e.g., the UE 104b) that does not directly communicate with the network 102 or the CN 108 (e.g., the communication channel link 103b is not established) communicates indirectly with the network 102 and the CN 108 using the SL communication channel 105 via a relay UE (e.g., the UE 104a), which can directly communicate with the network 102 and the CN 108 or indirectly communicate with the network 102 and the CN 108 via another relay UE that can directly communicate with the network 102 and the CN 108.

FIG. 1B illustrates a block diagram of an example wireless communication system for transmitting and receiving downlink, uplink and SL communication signals, in accordance with some arrangements of the present disclosure. In some arrangements, the system can transmit and receive data in a wireless communication environment such as the wireless communication network 100 of FIG. 1A, as described above.

The system generally includes the network 102 and UEs 104a and 104b, as described in FIG. 1A. The network 102 includes a Network transceiver module 110, a Network antenna 112, a Network memory module 116, a Network processor module 114, and a network communication module 118, each module being coupled and interconnected with one another as necessary via a data communication bus 120. The UE 104a includes a UE transceiver module 130a, a UE antenna 132a, a UE memory module 134a, and a UE processor module 136a, each module being coupled and interconnected with one another as necessary via a data communication bus 140a. Similarly, the UE 104b includes a UE transceiver module 130b, a UE antenna 132b, a UE memory module 134b, and a UE processor module 136b, each module being coupled and interconnected with one another as necessary via a data communication bus 140b. The network 102 communicates with the UEs 104a and 104b via one or more of a communication channel 150, which can be any wireless channel or other medium known in the art suitable for transmission of data as described herein.

The system may further include any number of modules other than the modules shown in FIG. 1B. Those skilled in the art will understand that the various illustrative blocks, modules, circuits, and processing logic described in connection with the arrangements disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present disclosure.

A wireless transmission from an antenna of one of the UEs 104a and 104b to an antenna of the network 102 is known as an uplink transmission, and a wireless transmission from an antenna of the network 102 to an antenna of one of the UEs 104a and 104b is known as a downlink transmission. In accordance with some arrangements, each of the UE transceiver modules 130a and 130b may be referred to herein as an uplink transceiver, or UE transceiver. The uplink transceiver can include a transmitter and receiver circuitry that are each coupled to the respective antenna 132a and 132b. A duplex switch may alternatively couple the uplink transmitter or receiver to the uplink antenna in time duplex fashion. Similarly, the Network transceiver module 110 may be herein referred to as a downlink transceiver, or Network transceiver. The downlink transceiver can include RF transmitter and receiver circuitry that are each coupled to the antenna 112. A downlink duplex switch may alternatively couple the downlink transmitter or receiver to the antenna 112 in time duplex fashion. The operations of the transceivers 110 and 130a and 130b are coordinated in time such that the uplink receiver is coupled to the antenna 132a and 132b for reception of transmissions over the wireless communication channel 150 at the same time that the downlink transmitter is coupled to the antenna 112. In some arrangements, the UEs 104a and 104b can use the UE transceivers 130a and 130b through the respective antennas 132a and 132b to communicate with the network 102 via the wireless communication channel 150. The wireless communication channel 150 can be any wireless channel or other medium known in the art suitable for downlink and/or uplink transmission of data as described herein. The UEs 104a and 104b can communicate with each other via a wireless communication channel 170. The wireless communication channel 170 can be any wireless channel or other medium suitable for SL transmission of data as described herein.

Each of the UE transceiver 130a and 130b and the Network transceiver 110 are configured to communicate via the wireless data communication channel 150, and cooperate with a suitably configured antenna arrangement that can support a particular wireless communication protocol and modulation scheme. In some arrangements, the UE transceiver 130a and 130b and the Network transceiver 110 are configured to support industry standards such as the Long Term Evolution (LTE) and emerging 5G and 6G standards, or the like. It is understood, however, that the present disclosure is not necessarily limited in application to a particular standard and associated protocols. Rather, the UE transceiver 130a and 130b and the Network transceiver 110 may be configured to support alternate, or additional, wireless data communication protocols, including future standards or variations thereof.

The processor modules 136a and 136b and 114 may be each implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, methods and algorithms described in connection with the arrangements disclosed herein may be embodied directly in hardware, in firmware, in a software module executed by processor modules 114 and 136a and 136b, respectively, or in any practical combination thereof. The memory modules 116 and 134a and 134b may be realized as RAM memory, flash memory, ROM memory, EPROM memory, EEPROM memory, registers, a hard disk, a removable disk, a CD-ROM, or any other form of storage medium known in the art. In this regard, the memory modules 116 and 134a and 134b may be coupled to the processor modules 114 and 136a and 136b, respectively, such that the processors modules 114 and 136a and 136b can read information from, and write information to, memory modules 116 and 134a and 134b, respectively. The memory modules 116, 134a, and 134b may also be integrated into their respective processor modules 114, 136a, and 136b. In some arrangements, the memory modules 116, 134a, and 134b may each include a cache memory for storing temporary variables or other intermediate information during execution of instructions to be executed by processor modules 116, 134a, and 134b, respectively. Memory modules 116, 134a, and 134b may also each include non-volatile memory for storing instructions to be executed by the processor modules 114 and 136a and 136b, respectively.

The network interface 118 generally represents the hardware, software, firmware, processing logic, and/or other components of the network 102 that enable bi-directional communication between Network transceiver 110 and other network components and communication nodes configured to communication with the network 102. For example, the network interface 118 may be configured to support internet or WiMAX traffic. In a typical deployment, without limitation, the network interface 118 provides an 802.3 Ethernet interface such that Network transceiver 110 can communicate with a conventional Ethernet based computer network. In this manner, the network interface 118 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 118 can allow the network 102 to communicate with other Network s or core network over a wired or wireless connection.

In some arrangements, each of the UEs 104a and 104b can operate in a hybrid communication network in which the UE communicates with the network 102, and with other UEs, e.g., between 104a and 104b. As described in further detail below, the UEs 104a and 104b support SL communications with other UE's as well as downlink/uplink communications between the network 102 and the UEs 104a and 104b. In general, the SL communication allows the UEs 104a and 104b to establish a direct communication link with each other, or with other UEs from different cells, without requiring the network 102 to relay data between UEs.

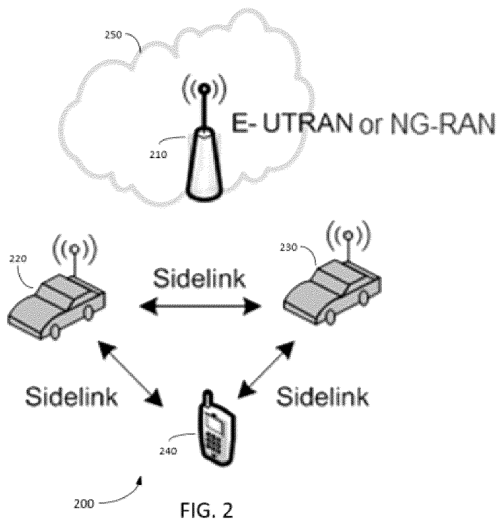

FIG. 2 is a diagram illustrating an example system 200 for SL communication, according to various arrangements. As shown in FIG. 2, a network 210 (such as network 102 of FIG. 1A) broadcasts a signal that is received by a first UE 220, a second UE 230, and a third UE 240. The UEs 220 and 230 in FIG. 2 are shown as vehicles with vehicular communication networks, while the UE 240 is shown as a mobile device. As shown by the SLs, the UEs 220-240 are able to communicate with each other (e.g., directly transmitting and receiving) via an air interface without forwarding by the base station 210 or the core network 250. This type of V2X communication is referred to as PC5-based V2X communication or V2X SL communication.

As used herein, when two UEs 104a or 104b are in SL communications with each other via the communication channel 105/170, the UE that is transmitting data to the other UE is referred to as the transmission (TX) UE, and the UE that is receiving said data is referred to as the reception (RX) UE.

With the development of wireless multimedia services, people's demand for high data rate and user experience is increasing, which may put forward higher requirements on system capacities and coverages of traditional cellular networks. On the other hand, application scenarios, such as public security, social networks, short-distance data sharing, and local advertising, have gradually increased people's demand for understanding and communicating with nearby people or things (e.g., proximity services). Traditional base station-centric cellular networks may have limitations in terms of high data rates and supports for proximity services. A device-to-device (D2D) communication technology emerges in response to the demand. An application of the D2D communication technology may reduce a burden of a cellular network, may reduce a battery power consumption of a user equipment, may increase a data rate, and/or may improve a robustness of a network infrastructure, which can well meet the requirements of the above-mentioned high data rate business and proximity services. D2D technology can be also called Proximity Services (ProSe), unilateral/sidelink (SL) communication. An interface between devices can be a PC5 interface.

Device using/utilizing/applying sidelink communication may support two resource modes (e.g., mode 1 and mode 2). For mode 1, a UE may use a resource scheduled by a network to transmit sidelink data. For mode 2, a UE may select a transmission resource by itself to transmit sidelink data.

In some arrangements, a licensed carrier refers to a carrier, frequency band, or spectrum that is licensed by a government or an authoritative entity, such as the Federal Communications Commission (FCC) in the United States and the European Telecommunications Standards Institute (ETSI) in Europe, to a service provider for exclusive use. An unlicensed carrier (or shared spectrum) refers to a carrier, frequency band, or spectrum that is not licensed by a government or another authoritative entity. Two or more service providers may operate in the unlicensed carrier.

In some arrangements a UE performs a channel access scheme referred to as Listen Before Talk (LBT) before performing data transmission on an unlicensed carrier. In the LBT procedure, the UE monitors a channel in the unlicensed carrier for an interval of time. In response to determining that the LBT procedure is successful, the UE can occupy the channel in the unlicensed carrier for an interval of time referred to as Channel Occupy Time (COT). The LBT procedure includes initial LBT procedure and non-initial LBT procedure. Compared to the non-initial LBT, the UE needs more time to perform the initial LBT procedure. The non-initial LBT procedure is performed within the COT.

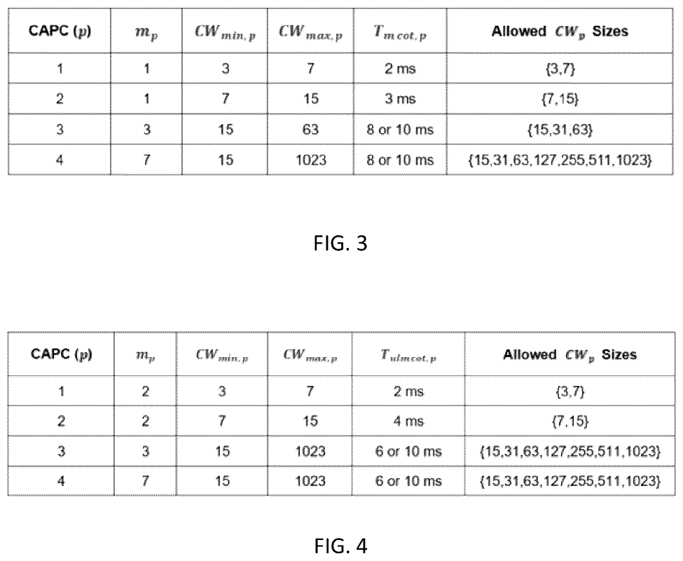

In some examples, the length of the COT (e.g., T_{ulm cot,p} or T_{m cot,p}) depends on an Channel Access Priority Class (CAPC) value used for the LBT procedure as shown in FIG. 3, which is a table illustrating values of CAPC p, sensing slot for the given priority class (mₚ) minimum contention windows (CW_{min, p}) for the given priority class, maximum contention windows (CW_{max, p}) for the given priority class, the maximum length of the COT (T_{m cot,p}) for the given priority class, and allowed contention window sizes (CWₚ) for the given priority class. In response to determining that the LBT procedure is successful, the UE can share the COT to another UE. The UE can use the COT shared by other UE to perform channel access.

For priority classes p=3 and p=4, if the absence of any other technology sharing the channel can be guaranteed on a long term basis (e.g., by level of regulation), T_{m cot,p}=10 ms, otherwise, T_{m cot,p}=8 ms.

FIG. 4 is a table illustrating values of CAPC p for uplink, sensing slot for the given priority class (mₚ) minimum contention windows (CW_{min, p}) for the given priority class, maximum contention windows (CW_{max, p}) for the given priority class, the maximum length of the COT (T_{m cot,p}) for the given priority class, and allowed contention window sizes (CWₚ) for the given priority class. For priority classes p=3 and p=4, T_{m cot,p}=10 ms if the higher layer parameter absenceOfAnyOtherTechnology-r14 or absenceOfAnyOtherTechnology-r16 is provided. Otherwise, T_{m cot,p}=6 ms. When T_{m cot,p}=6 ms, it may be increased to 8 ms by inserting one or more gaps. The minimum duration of a gap shall be 100 us. The maximum duration before including any such gap shall be 6 ms.

In some arrangements, a UE uses SL resource allocation Mode 2 to transmit data. Mode 2 includes multiple mechanisms such as full sensing only, partial sensing only, random resource selection only, or any combination(s). In Mode 2, in Step 1, the UE selects the data transmission parameter including at least one of a Hybrid Automatic Repeat Request (HARQ) retransmission number, a resource reselection counter value, a transmission period, a resource reservation interval, an amount of frequency resources, a packet delay budget, a number of sub-channels to be used for a Physical SL Shared Channel (PSSCH) transmission or a Physical SL Feedback Channel (PSFCH) transmission, a resource pool, and so on.

Then, in Step 2, the UE uses the selected data transmission parameter to determine the candidate resource set. In Step 3, the UE selects the initial transmission from the determined candidate resource set. In Step 4, the UE, if needed, selects multiple re-transmission resource from the determined candidate resource set for the selected initial transmission resource. The number of re-transmission resource depends on the selected HARQ re-transmission number. In Step 5, if needed, the UE selects the period transmission resource from the determined candidate resource set. The period depends on the resource reservation interval. In step 6, the UE performs logical channel prioritization including selecting a destination, selecting the logical channel from the selected destination and multiplex the data from the selected logical channel to the MAC PDU.

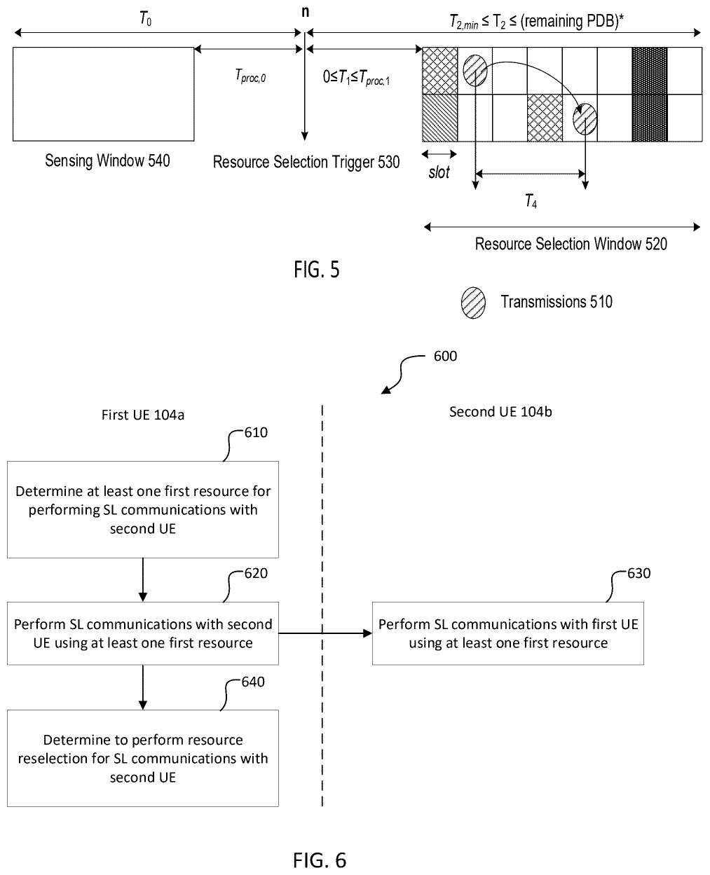

FIG. 5 is a diagram illustrating Mode 2 resource selection, according to various arrangements. To determine the candidate resource set in Step 2, in resource selection, the Media Access Control (MAC) layers considers a Transport Block (TB) transmission, characterized by a set of transmission parameters such as one or more of resource pool, L1 priority, Packet Delay Budget (PDB), number of subchannels LsubCH to be used in a slot, and the resource reservation interval P_{rsvp_Tx} in units of msec. The MAC layer requests the Physical (PHY) layer to exclude a set of resources in the selection window based on sensing of subchannels.

As shown in FIG. 5, resources for transmissions 510 of two TBs are selected at random, thus resulting in two-slot gap between the transmissions. Transmission time difference is represented as T₄. During sensing, each single slot is a resource, and the UE determines all single slot resource in resource selection window 520 as candidate resources. The UE detects the level of Reference Signal Received Power (RSRP) over the slots in which SCI-1 reservations have been received, and projects the RSRP on the reserved resources under test. During the exclusion, the RSRP is tested against a threshold to assess the acceptability of the level of interference in case a collision may occur in the said resource under test. After the exclusion procedure, the remaining resources in resource selection window 520 are determined as the candidate resource set. The resource selection trigger 530 occurs at time n, which is the boundary between T₀ and T₂. The sensing is performed within the sensing window 540.

In some arrangements, SL communications can be performed on unlicensed carriers. For each selected transmission resource, a UE needs to perform channel access, and in response to determining that channel access successful, the UE can use the selected transmission resource to transmit SL data.

In some examples, LBT failure can impact the SL resource selection and reselection procedure. For example, a UE triggers resource selection or reselection upon receiving an LBT failure indication from PHY for a PSSCH transmission. Conventionally, it is not certain new resource selection or reselection trigger is also applicable for the Multiple Consecutive Slots transmission (MCSt). SL LBT failure indication granularity is per Resource Block (RB) set.

FIG. 6 is a flowchart diagram illustrating an example method 600 for performing resource selection and reselection for SL communications, according to various arrangements. The method 600 can be performed using the network 100 and/or the system 200.

At 610, the first UE 104a determines at least one first resource for performing SL communications with the second UE 104b. At 620, the first UE 104a performs with the second UE 104b the SL communications. At 630, the second UE 104b performs with the first UE 104a the SL communications. At 640, the first UE 104a determines to perform resource reselection for the SL communications with the second UE 104b.

For SL communications over an unlicensed carrier, the LBT failure indication is per RB set, and depends on the TB type transmitted over this RB set. The different transmission types for LBT failure indication need to be differentiated. The SL communications at 620 and 630 include at least one of SL Synchronization Signal Block (SSB) transmission, SL PSSCH transmission, PSFCH transmission, and so on. With these different transmission types, LBT failure can also be separated into three types including SSB LBT failure indication, PSSCH transmission LBT failure indication, and PSFCH transmission LBT failure indication. In some arrangements, the first UE 104a triggers resource reselection in response to receiving an LBT failure indication, which can be one of the three types of failure indications.

For PSSCH transmission, the first UE 104a triggers a resource reselection due to PSSCH transmission LBT failure, given that the PSSCH transmission is triggered by MAC layer's MAC PDU transmission. For PSFCH transmission, the first UE 104a perform LBT detection due to transmit a HARQ feedback of peer UE's MAC PDU on PSFCH resource. The first UE 104a can be configured with a Transmission (TX) resource pool and Reception (RX) resource pool. The TX resource pool and the RX resource pool can be the same resource pool or different resource pools for the first UE 104a. In some examples, the TX resource pool and the RX resource pool may not overlapping (e.g., the TX resource pool and the RX resource pool include different RB set) from the perspective of the same first UE 104a. In some examples, the TX resource pool and the RX resource pool may be overlapping (e.g., the TX resource pool and the RX resource pool include the same RB set) from the perspective of the same first UE 104a, and the LBT failure RB set is the shared RB set. For example, the TX resource pool includes RB set 1 and set 2, the RX resource pool includes RB set 2 and set 3, and LBT failure is detected on RB set 2 which is included in both the TX resource pool and the RX resource pool.

In the examples in which the TX resource pool and the RX resource pool are not overlapping, given that LBT failure of RB set on PSFCH resource of the RX resource pool is not the RB set of TX resource pool, and LBT detection granularity is RB set, then LBT failure of PSFCH does not influence the TX resource pool. In some examples, for resource re-selection, in response to determining that the LBT for PSFCH has failed, LBT failure RB set is within the RB set of TX resource pool.

In some arrangements, the first UE 104a triggers resource reselection for the PSSCH in response to at least one of determining that LBT failure is on PSFCH/SSB, determining that RB set of PSFCH LBT failure is within the TX resource pool, or selecting the grant to transmit PSSCH.

In some arrangements, the SL communications includes a SSB transmission, and the resource reselection at 640 is performed in response to the first UE 104a determining LBT failure for the SL communications and a frequency resource (e.g., RB set) used to transmit the SSB transmission is within a TX resource pool (transmission frequency resource pool) of the first UE 104a.

In some arrangements, the SL communications includes a PSFCH transmission. The resource reselection at 640 is performed in response to the first UE 104a determining that the LBT failure for the SL communications and a frequency resource (e.g., RB set) used to transmit the PSFCH transmission is within a TX resource pool (transmission frequency resource pool) of the first UE 104a.

In some examples, the first UE 104a selects the transmission resource by selecting the HARQ re-transmission number, selecting the initial transmission resource, selecting the HARQ-retransmission resource according to the selected HARQ re-transmission number, and selecting the period transmission resource according to the initial transmission and HARQ re-transmission. Due to LBT failure, the real or actual number of transmission may be less than the selected HARQ re-transmission.

In some examples, to address insufficient transmission number, additional transmission resources are selected by the network configuring increased HARQ re-transmission numbers, the first UE 104a selecting a greater HARQ retransmission number, or the first UE 104a selecting a number of transmission resources greater than the selected number of HARQ retransmissions.

In the examples in which the first UE 104a selects a number of transmission resources greater than the selected number of HARQ retransmissions, some selected re-transmission resources may be available after the transmission is successful. The actual number of transmission can be larger than the selected number of re-transmission. For example, each re-transmission resource is LBT successful.

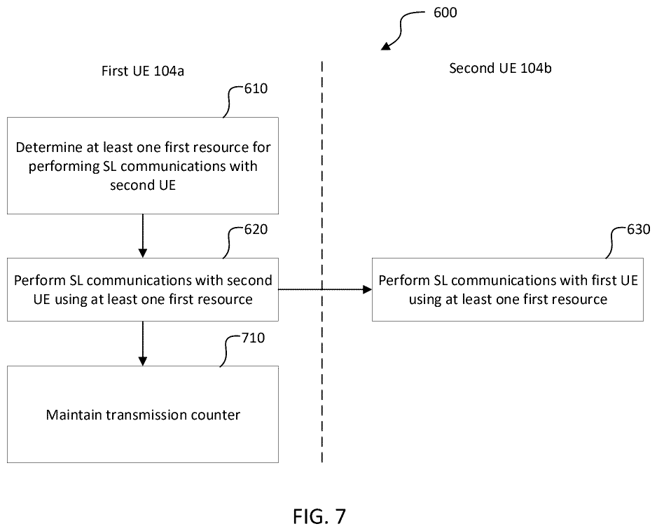

In some examples, a counter procedure can be used to count the actual number of re-transmissions. FIG. 7 is a flowchart diagram illustrating an example method 700 for performing resource selection and reselection for SL communications, according to various arrangements. The method 700 can be performed using the network 100 and/or the system 200. At 610, the first UE 104a determines at least one first resource for performing SL communications with the second UE 104b. At 620, the first UE 104a performs with the second UE 104b the SL communications. At 630, the second UE 104b performs with the first UE 104a the SL communications.

At 710, the first UE 104a maintains a transmission counter to count the actual number of retransmissions for each HARQ process. For example, if the transmission is performed, the counter is increased by 1. In some examples, in response to determining that the counter reaches a selected maximum number of retransmissions, the first UE 104a drops the remaining re-transmission resource(s) if there are available remaining retransmission resources. In some examples, in response to determining that the counter reaches a selected maximum number of re-transmission, the first UE 104a determines not to use the remaining re-transmission resource(s) if there are available remaining retransmission resources. In some example, in response to determining that the counter reaches a selected maximum number of retransmissions, the first UE 104a flushes the HARQ buffer. In some examples, in response to determining that the counter reaches a selected maximum number of re-transmission, the first UE 104a considers the remaining re-transmission resource(s) for transmission of another MAC PDU if there are available remaining retransmission resources. In some arrangements, the maximum number of retransmissions equals to the selected HARQ retransmission number.

In some arrangements, the at least one first resource includes a plurality of first resources. Determining the at least one first resource for performing the SL communications with the second UE 104b at 610 includes determining, by the first UE 104a, a HARQ retransmission number and determining, by the first UE 104a, a number of the plurality of first resources based on the HARQ retransmission number (e.g., the number of first resources is greater than the HARQ transmission).

In some arrangements, performing the SL communications includes increasing a count indicated by a counter in response to retransmitting, by the first UE 104a to the second UE 104vb, a first transmission (e.g., a first PDU). The method 700 can further includes dropping at least one remaining resource of the plurality of first resources in response to determining that the count reaches the HARQ retransmission number and that the at least one remaining resource remains unused for retransmitting the first transmission. The method 700 can further includes using at least one remaining resource of the plurality of first resources to transmit a second transmission (e.g., a second PDU) in response to determining that the count reaches the HARQ retransmission number and the at least one remaining resource remains unused for retransmitting the first transmission. In some examples, the UE (e.g., the UE transceiver module 130a or 130b) may have two different communication modules, e.g., a first module and a second module. The first module can be an LTE SL module, and the second module can be an NR SL module. The UE manages resource selection for LTE SL and NR SL separately.

In some arrangements, transmissions on the second module may cause interference on transmission of first module. FIG. 11 is a diagram illustrating frame structures of 15 kHz and 30 kHz Subcarrier Spacing (SCS), according to various arrangements. In some examples, the first module use 30 kHz SCS, and the second module use 15 kHz SCS. Then, one resource in first module overlaps with two resources in second module. For example, for first module (30 kHz), each resource is a subframe having 14 symbols. For second module (15 kHz), each resource is a slot, each of the slot having 7 symbols.

The first module can perform Automatic Gain Control (AGC) based on at least one first symbol of the subframe, for example the symbols overlapping with first slot (e.g., 0-7 symbols). If only second slot is transmitted, due to absent of transmission on first slot, the first module may evaluate the AGC wrongly. Therefore, in this case, if transmission is performed or detected on first module, the second module can either not transmit on first and second resources or transmit at least on first resource. In other words, transmission on only the second resource is not allowed.

To address such issues, the first module needs to share the candidate resource information (e.g., sensing result) with second module. The candidate information includes at least one of time and frequency locations of reserved resources by other first module UEs, determined based on decoded SCIs, SL RSRP measurement results, resource reservation periods based on decoded SCI and for own first module transmissions, priority based on decoded SCI and for own first module transmissions, time and frequency location of resources used for own first module transmissions, candidate resource set S_{A} or S_{B}, SL RSSI measurements, first module logical subframe related information, resources corresponding to half-duplex subframes which are not monitored by the first module UE, and so on.

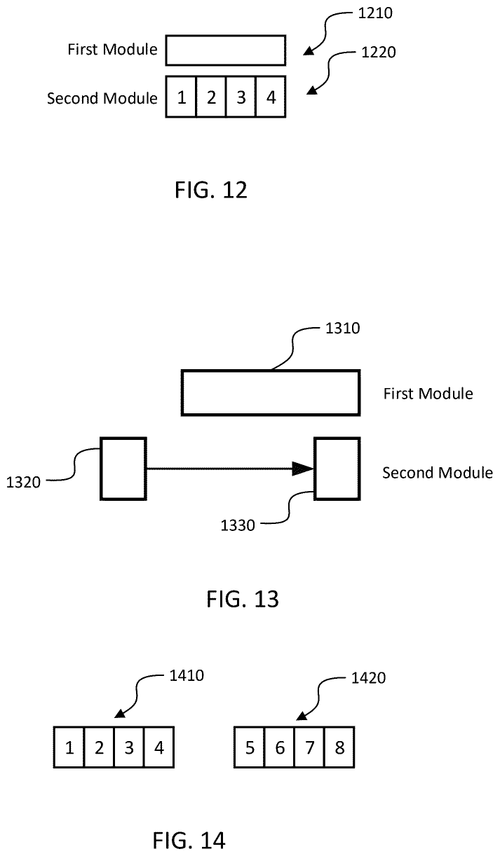

In some arrangements, the first overlapping resource and subsequent overlapping resource of second module relate to the resources overlapping with same resource of first module. FIG. 12 is a diagram illustrating an example resource 1210 of the first module and example resources 1220 of the second module, according to various arrangements. As shown in FIG. 12, resource 1 of the resources 1220 is the first overlapping resource that overlaps with the resource 1210 in the time domain, and resources 2, 3, 4 of the resources 1220 are subsequent overlapping resources. The first overlapping resource 1 and subsequent overlapping resources 2, 3, and 4 overlap with same resource 1210 of first module. The resource 1210 can be a slot or subframe. For 30 kHz SCS, the subsequent overlapping resource is the second overlapping resource 2.

In some arrangements, at least the first resource 1 overlapping with first module resource 1210 is selected, and the subsequent overlapping resources 2, 3, and 4 in second module can be selected. The arrangement disclosed herein determines the manner in which the resources are overlapping. The starting symbol of the first of the overlapping NR SL slots is assumed to be aligned with the first symbol of the LTE SL subframe. For NR SL with 15/30 kHz SCSs, NR SL UE avoids selecting resources for PSCCH/PSSCH transmissions in the examples in which the corresponding PSFCH transmission occasions overlap with LTE SL reservations in the time domain. Such mechanism is for Mode 2 operation.

The assumption for co-channel coexistence includes one UE being equipped with both LTE V2X module and NR V2X module. LTE V2X module and NR V2X module perform sensing with LTE frame structure and NR frame structure interdependently and exchange the sensing result to further perform resource exclusion. When data transmission on LTE slot use 15 kHz SCS and NR slot is configured with 30 kHz SCS, due to differentiation of frame structures, if only NR slot 2 is selected, LTE module of other UE cannot detect such transmission. Thus, AGC leads to reception issues. To address such issues, NR SL UE selects in MAC layer at least the first of NR SL slots overlapping with an LTE SL subframe, and can select the subsequent overlapping NR SL slot in MAC layer.

However, while currently a UE is configured to select one resource within resources of second module overlapping with resource of first module, the arrangements disclosed herein relate to selecting a resource within resource pool. The UE (e.g., the first UE 104a) selects the resource one by one. The candidate resource set are separated into types including the resource which is first overlapping resource, the resource which is a subsequent overlapping resource (corresponding first slot resource is selected), and the resource which is subsequent overlapping resource (corresponding first slot resource is unselected or not a candidate resource).

Then, for each resource selection, the UE can select resource. In some examples, the resource can be a first overlapping resource. In some examples, the resource is subsequent overlapping resource, and corresponding first overlapping resource is selected.

In some examples, TB association is checked. To assure AGC, two slots may be used for a same TB, or the transmission power for the two slots may be the same. Additionally, due to the sensing result needs to be exchanged between LTE V2X module and NR module model, NR SL entity receives the overlapping resource from LTE entity after NR SL resource selection has been down. Then UE may finds that the selected resource is the subsequent overlapping transmission resource (e.g., not the first transmission resource) and the first overlapping resource is not selected. To address such issues, for the selected resource, if the resource is the subsequent overlapping resources and the corresponding first overlapping resource is not selected, then at least one of the following is triggered: resource re-selection, dropping the selected resource, determining the resource is not used, reselecting another resource to replace this resource.

In some examples, in response to determining that the selected resource is the subsequent overlapping resource and the first overlapping resource is not selected, at least one of the following is triggered: resource re-selection, dropping the selected resource, dropping the selected resource, determining the resource is not used, reselecting another resource to replace this selected resource.

In some arrangements, the second UE 104b has selected the first and at least one subsequent overlapping resources simultaneously. Due to some conditions the transmission on first overlapping resource is not performed, the subsequent overlapping resources are not used.

In some examples, one transmission may not be performed due to at least one of following: the transmission is down-prioritized, no MAC PDU is obtained, the resource is pre-emption or re-evaluated or conflicted, the grant of this transmission is not in the Discontinuous Reception (DRX) active time of receiving device, or the resource is cleared, or the previous transmission corresponding to same MAC PDU is HARQ-enable and HARQ ACK is received in some examples. In some examples, for negative-positively acknowledgement, one transmission may not be performed due to the previous transmission corresponding to same MAC PDU is HARQ-enabled, and all intended HARQ ACK is received(i.e. HARQ ACK from all receiving device is received). In some examples, one transmission may not be performed due to for negative-only acknowledgement, the previous transmission corresponding to same MAC PDU is HARQ-enable, if negative-only acknowledgement was enabled in the SCI, and no negative acknowledgement was received for this transmission of the MAC PDU.

Then if the transmitted resource not used for transmission is the first overlapping resource, then for the subsequent overlapping the UE can perform at least one of: dropping subsequent overlapping, determining the resource is not used, selecting another resource to replace the dropped resource, triggering resource-re-selection, or considering the subsequent overlapping resource to be down prioritized.

In some arrangements, dropping a resource refers to the UE performing at least one of removing the resource, determining that the resource is not used, clearing the resource, and so on.

In some examples, the first overlapping resource overlapping with an resource of first module is not transmitted due at least one of the UE dropping subsequent overlapping resource, determining that the resource is not used, or selecting another resource to replace the dropped resource. In some examples, the SL transmission is down prioritized. In some examples, no MAC PDU is obtained. In some examples, the resource is pre-emption or re-evaluated or conflicted. In some examples, the NR SL grant is not in the active time. In some examples, the resource is cleared due to resource re-selection is triggered. In some examples, for unicast the previous transmission corresponding to same MAC PDU is HARQ-enabled, and HARQ ACK is received. In some examples, for groupcast option 1, the previous transmission corresponding to same MAC PDU is HARQ-enabled and all intended HARQ ACK is received. In some examples, for groupcast option 2, the previous transmission corresponding to same MAC PDU is HARQ-enabled, if negative-only acknowledgement was enabled in the SCI, and no negative acknowledgement was received for this transmission of the MAC PDU.

FIG. 13 is a diagram illustrating resources of the first module and the resources of the second module, according to various arrangements. In some examples, with respect to PSFCH restriction, for NR SL with 15/30 kHz SCSs, NR SL UE avoids selecting resources for PSCCH/PSSCH transmissions 1320 where the corresponding PSFCH transmission occasions 1330 overlap with LTE SL reservations 130 in the time domain.

Considering that current MAC specification only capture how UE select the resource, the restriction can be captured by two options in stage3. Option 1 includes, for NR SL with 15/30 kHz SCSs, NR SL UE avoids selecting resources for PSCCH/PSSCH transmissions where the corresponding PSFCH transmission occasions overlap with LTE SL reservations in time domain. Option 2 includes the UE excluding the resources for PSCCH/PSSCH transmissions where the corresponding PSFCH transmission occasions overlap with LTE SL reservations in time domain.

In some arrangements, the UE excluding the resources for transmissions where the corresponding PSFCH transmission occasions overlap with first module reservations in time domain.

In some examples, due to the sensing result needs to be exchanged between first model and second model, second module receives the PSFCH overlapping from first model after NR SL resource selection has been down. In this case, if the UE determines that the selected resource has PSFCH overlapping with resource of first module, the UE performs at least one of triggers resource re-selection, dropping the selected resource, determining that the resource is not used, or reselects another resource to replace this resource. In some arrangements, for the selected resource, in response to determining that the resource having PSFCH transmission occasions overlaps with first module resource reservations in the time domain, the UE (e.g., the UE 104a) triggers at least one of resource re-selection, drops the selected resource, or re-selects another resource to replace the selected resource.

In some examples, all resources having corresponding PSFCH transmission resources may overlap with first module reservations in the time domain, then resource pool re-selection is triggered. In some examples, there are resources having PSFCH resources not overlap with first module resources, and the remaining resources does not meet the QoS requirement (e.g., PDB).

In some arrangements, the UE triggers resource pool re-selection. In response to the UE (e.g., the UE 104a) selects the resource pool, the UE selects the resource pool having PSFCH resource not overlapping with first module resource reservation.

In some arrangements, the UE triggers resource pool re-selection. In response to the UE selecting the resource pool, the UE selects the resource pool having PSFCH resource not overlapping with first module resource reservation. In some examples, in response to determining that all PSFCH transmission resources that overlap with resource reservations of first module in time domain, the UE triggers resource pool reselection. In some examples, the remaining PSFCH resource does not meet the QoS requirement (e.g., PDB).

In some arrangements, to ensure the average power of all overlapping resources does not influence the resource of first module, the data (e.g. MAC PDU) transmitted on all overlapping resources is the same data.

In some arrangements, if a resource is selected by the UE and the resource is subsequent overlapping resource, then this resource is the re-transmission resource of the first overlapping resource.

In some arrangements, to ensure the average power of all overlapping resources((first overlapping resource and subsequent overlapping resource)) does not influence the resource of first module, the data transmitted on all overlapping resources is transmitted to same destination.

In some arrangements, during LCP, if the grant is the subsequent overlapping resources, UE selects the first destination in response to determining that the first destination is the destination of corresponding first overlapping resources.

In some arrangements, during LCP, if the grant is the subsequent overlapping resources, UE selects the first destination in response to determining that the TX power for transmitting data to the first destination is lesser than or equal to the TX power for transmitting data to the destination on corresponding first overlapping resources.

In some arrangements, during LCP, if the grant is the subsequent overlapping resources, UE selects the first destination in response to determining that the TX power for transmitting data to the first destination is lesser than or equal to the TX power for transmitting data to the destination of corresponding first overlapping resources plus a first threshold. The first threshold is configured by network.

In some arrangements, the resources overlapping (first overlapping resource and subsequent overlapping resources) with same resource of first module can be considered as a MCSt resource.

In some arrangements, after UE obtains a COT after LBT successful, if no transmission is performed within the COT, UE may lose the obtained COT due to the IDLE channel being detected by other UE. To address such issues, the UE can select a MCSt resource having one or more transmission resources (e.g., a slot, or a symbol, or a subframe, a mini-slot). In some arrangements, for initial transmission resource selection, a MCSt resource is selected, each slot within the MCSt resource is for the initial transmission. In some arrangements, for re-transmission resource selection, each slot within the MCSt resource is for retransmission. FIG. 14 is a diagram illustrating example MCSt resources 1410 and 1420, according to various arrangements. For example, MCSt resource 1410 includes slots 1, 2, 3, and 4 for the initial transmission, and MCST resource 1420 includes slots 5, 6, 7, 8 for the re-transmission.

In some arrangements, a second MCSt resource e.g., 1420 is selected for retransmission of a first MCSt resource e.g., 1410. In some arrangements, the first slot (e.g., slot 5) in second MCSt resource 1420 is for re-transmission of first slot (e.g., slot 1) within first MCSt resource 1410. The second slot (e.g., slot 6) in second MCSt resource 1420 is for retransmission of second slot (e.g., 2) within first MCSt resource 1410, and so on. In some arrangements, each slot within second MCSt resource 1420 is for retransmission of any slot within first MCSt resource 1410.

In some arrangements, the association between prior transmission slot and re-transmission slot depends on the prior transmission result. The first slot (e.g., slot 5) in second MCSt resource 1420 is for retransmission of first slot (e.g., slot 1) for which the retransmission is needed within the first MCSt resource 1410. The second slot (e.g., slot 6) on which the re-transmission is required in second MCSt resource 1420 is for re-transmission of second slot (e.g., slot 2) for which the re-transmission is required within first MCSt resource 1410, and so on.

In some arrangements, the UE determines that the slot for which the re-transmission is required in response to determining at least one of the HARQ feedback is disabled for the data to be transmitted on the slot, or the HARQ feedback is enabled for the data to be transmitted on the slot and HARQ NACK is received.

In some examples, MCSt-1 1410 has slots 1, 2, 3, 4, and MCST-2 1420 has slots 5, 6, 7, 8. In the beginning, slot 5 is used for the re-transmission of slot 1, slot 6 is used for re-transmission of slot 2, and so on. After performing transmission on slots 1, 2, 3, 4, the transmission on slot 1 is successful due to HARQ enabled and HARQ ACK is received, transmission on slots 3, and 4 fails due to HARQ enabled and HARQ NACK being received, and transmission on slot 2 is HARQ disabled. Then re-transmission of slot 1 is not required, and retransmission of slots 2, 3, and 4 is needed. Slot 2 is first slot needing retransmission, slot 3 is second slot needing re-transmission and slot 4 is third slot needing re-transmission. Therefore, retransmission resource slot 5 is re-associated to slot 2, slot 6 is re-associated to slot 3, slot 7 is re-associated to slot 4, and slot 8 is dropped given that no fourth slot requiring re-transmission exits (only 3 slots needs to be re-transmitted, i.e. slots 2, 3, 4).

In some arrangements, based one the HARQ re-transmission number, more than 2 MCSt resources are selected. Then the first MCSt resource is for initial transmission, subsequent MCSt resource is retransmission. Then when determining the re-transmission association, each MCSt resource can be considered as retransmission of prior MCSt resource. The first slot in MCSt resource is for re-transmission of first slot for which the re-transmission is required within prior MCSt resource. The second slot on which the re-transmission is required in MCSt resource is for retransmission of second slot for which the retransmission is required within prior MCSt resource, and so on.

For example, 3 MCSt resources are selected for initial transmission and retransmission. The second MCSt resource depends on the transmission result of the first MCSt resource. The third MCSt resource depends on the transmission result of the second MCSt.

In some arrangements, the MCSt needs UE having large new data to be transmitted. In some arrangements, the UE separates the subchannel size into N part, N equals to the number of slots within the MCSt resource. In some arrangements, the number of slots is configured by network. The number of slots can be configured at least one of following per priority of logical channel, per PC5 5G QoS Index (PQI) (, per buffer size, per buffer size range, per buffer size index, per buffer size threshold, per CAPC value, per CAPC value threshold, per COT duration, per COT duration threshold, per CBR, per CBR threshold, per CBR range, per destination. In some arrangements, the buffer size is the data volume calculated by the PDCP entity. In some arrangements, the buffer size is the data volume calculated by the RLC entity. In some arrangements, the buffer size index identifies a buffer size range, for example, as shown in FIG. 15, which is a table illustrating buffer size levels for a 5-bit buffer size field.

In some arrangements, the resource selection procedure is performed per HARQ group, each HARQ group includes more than one HARQ process. The number of HARQ processes equals to the number of slot within MCSt. After MCSt resource is selected, the UE allocate the slot resource within MCSt to different HARQ process.

In some arrangements, each slot within the MCSt resource is used to transmit same data. If a MCSt resource is selected for initial transmission, the first slot within the MCSt is for initial transmission, the remaining slot within the MCSt is for re-transmission of the first slot. If a first MCSt resource is selected for retransmission of second MCSt resource, then each slot within first MCSt resource is for retransmission of first slot of second MCSt resource. In some arrangements, HARQ re-transmission number equals to the number of MCSt resources. In some arrangements, HARQ re-transmission number equals to the number of MCst resource times N, where N is a integer. In some arrangements, the number of slot within MCSt resource equals to the HARQ re-transmission number times N, N is a integer.

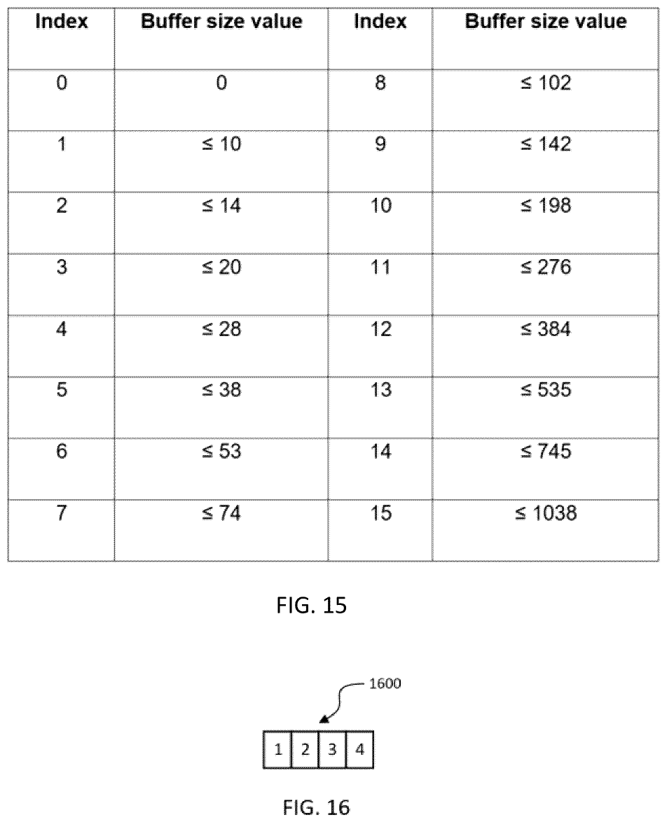

In some arrangements, if there is a MCSt resource where some slot is selected and another slot is unselected, then select the adjacent slot (e.g., next slot) corresponding to the selected slot within the same MCST resource. For example, FIG. 16 is a diagram illustrating example MCSt resource 1600, according to various arrangements. The single slot 2 of the resource 1600 is selected given that slot 1 is selected.

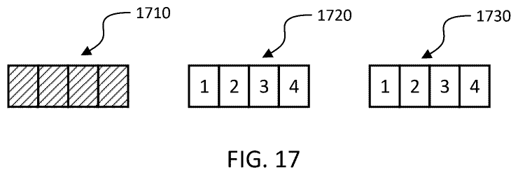

FIG. 17 is a diagram illustrating example MCSt resources 1710, 1720, and 1730, according to various arrangements. In some arrangements, if there is no MCSt resource 1710 where unselected slot is available, then a MCSt resource is randomly selected, and the first slot within the selected MCSt resource is selected. For example, MCSt resource 1720 and MCSt resources 1730 are randomly selected, and the single slot resources 1 in each of MCSt resources 1720 or 1730 are selected.

In some arrangements, each slot resource within MCSt resource is used to transmit the data to same destination. In some arrangements, during LCP, the first UE selects the first destination in response to determining that the grant is not the first slot resource within MCSt resource, the first destination is the destination to which the data is transmitted on prior slot within MCSt resource including the grant, and the prior slot is the slot prior to the grant within same MCSt resource. For example, for MCSt resource having slots 1, 2, 3, and 4, slot 1 is the prior slot to slot 2, slots 1 and 2 are prior slots to slot 3, slots 1, 2, 3 are prior slots to slot 4.

For another example, for a MCSt resource having slots 1, 2, 3, 4, slot 1 is the prior slot to slot 2, slot 2 is the prior slot to slot 3, slot 3 is the prior slot to slot 4.

In some arrangements, each MCSt resource is used to transmit the data to same destination. In some arrangements, during LCP, the first UE selects the first destination in response to determining that the grant is not the first slot resource within MCSt resource, the first destination is the destination to which the data is transmitted on first slot within same MCSt resource.

In some arrangements, the SL communications is performed using a first radio module and a second module. The first module is different from the second module. In some examples, the first module includes LTE SL module, and the second module includes NR module. In some examples, the module is a communication module, the module includes at least one of a LTE SL module, LTE V2X module, NR V2X module, or a NR SL module.

In some arrangements, the at least one first resource is determined by first wireless communication device in response to determining at least one of the at least one first resource is a first overlapping resource (e.g., a slot) that overlaps with a time resource (e.g., a subframe) of the first module or the at least one first resource is a subsequent overlapping resource (e.g., a slot that is not the first overlapping slot) that overlaps with the time resource of the first module(a corresponding first overlapping resource overlapping with same time resource of the second module is selected).

In some arrangements, in response to determining that the at least one resource is a subsequent overlapping resource, a first overlapping resource is not selected, and at least one of the following is performed: triggering resource reselection, dropping the selected at least one first resource, re-selecting at least one second resource different from the at least one first resource, using the at least one second resource to replace a first slot resource, or aborting transmission on the first slot resource.

In some arrangements, the at least one first resource is determined to be a subsequent overlapping resource. The first UE 104a does not transmit a transmission on the first overlapping resource. In some arrangements, the first UE 104a determines to not transmit a transmission on a first overlapping resource in response to determining at least one of the transmission is down-prioritized, no MAC PDU is obtained, the first resource is preempted, re-evaluated, or conflicted with another resource, an SL grant is not in an DRX active time, the first slot resource is cleared in response to triggering resource re-selection, for unicast, a previous transmission corresponding to a same MAC PDU is Hybrid Automatic Repeat Request (HARQ)-enable, and HARQ ACK is received, for groupcast option 1(negative-positive acknowledge), the previous transmission corresponding to a same MAC PDU is HARQ-enable, and all intended HARQ ACK is received, or for groupcast option 2(positive only acknowledgement), the previous transmission corresponding to the same MAC PDU is HARQ-enabled, and Negative-Only Acknowledgement (NACK) is enabled in SL Control Information (SCI) and no negative acknowledgement was received for a transmission of the MAC PDU.

In some arrangements, the first UE 104a performs at least one of dropping a subsequent overlapping resource, selecting another resource to replace a dropped resource, triggering resource reselection, or down-prioritizing the subsequent overlapping resource. In some arrangements, the first UE 104a determines the at least one first resource by excluding at least one resource for transmitting a PSCCH or at least one resource for transmitting PSSCH. A PSFCH transmission occasions corresponding to the PSCCH or the PSSCH overlaps with at least one SL reservation in a time domain.

In some arrangements, in response to determining that the at least one first resource has a PSFCH transmission occasion that overlaps with at least one SL reservation in a time domain, the first UE 104a performs at least one of triggering resource reselection, dropping the selected at least one first resource, or reselecting at least one second resource to replace the selected at least one first resource.

In some arrangements, in response to determining that all PSFCH transmission resources overlap with at least one SL reservation in a time domain, the first UE 104a triggers resource pool reselection. In some arrangements, the first UE 104a selects a resource pool having a PSFCH resource that does not overlap with at least one SL reservation in a time domain.

In some arrangements, the at least one first resource comprises two or more slots. In some examples, in response to selecting the at least one first resource for an initial transmission, at least one of each slot in the at least one first resource is for the initial transmission, or determining at least one second resource for re-transmission (each slot in the at least one second resource is for re-transmission of a slot in the at least one first resource). In some examples, a number of single slots in the at least one first resource is configured by a network. In some examples, the number of single slots in the at least one first resource is configured in granularity of at least one of per data value, per CAPC value, per priority, per destination L2 Identifier (ID), per service type, or per CBR.

FIG. 8 is a flowchart diagram illustrating an example method 800 for performing COT sharing, according to various arrangements. The method 800 can be performed using the network 100 and/or the system 200. At 810, the second UE 104b sends COT sharing information to the first UE 104a, the COT sharing information indicates sharing of a COT of the second UE 104b. The second UE 104b occupies the COT corresponding to the COT of the second UE 104b in response to performing a channel access procedure (e.g., LBT) on a carrier (e.g., an unlicensed carrier). At 820, the first UE 104a receives from the second UE 104b the COT sharing information. At 830, the first UE 104a determines the at least one resource for the COT of the second UE 104b.

In some arrangements, the first UE 104a can transmitting COT assistance information to the second UE 104b, based on which the second UE 104b can determine the COT sharing information. In some examples, the TX resource pool of the second UE 104b is different from the TX resource pool of the first UE 104a. The COT sharing assistance information can include timing slot, RB set index, resource pool index, number of RB set, subchannel size, and so on. In some arrangements, the method 800 further includes transmitting, by the first UE 104a to the second UE 104b, the COT assistance information for a desired COT, the COT assistance information includes at least one of a timing slot; an RB index, a resource pool index, a number of RB sets, or a subchannel size.

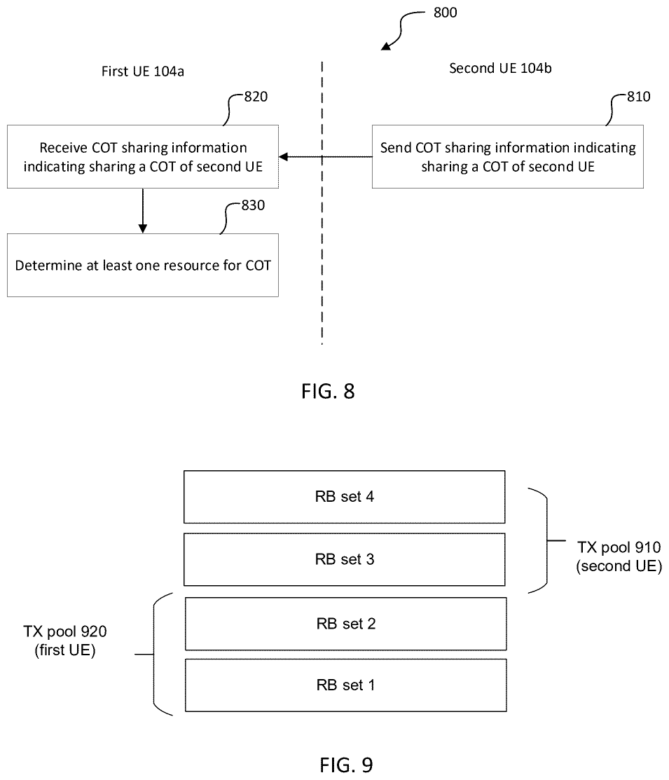

FIG. 9 is a diagram illustrating transmission resource pools of an initiating UE (e.g., the second UE 104b) and a responding UE (e.g., the first UE 104a), according to various arrangements. The TX resource pool 910, which includes RB sets 3 and 4, is for the second UE 104b. The TX resource pool 920, which includes RB sets 1 and 2, is for the first UE 104a. In the examples in which the shared COT is not within the selected resource pool, then the first UE 104a can trigger resource re-selection to select a TX resource pool (e.g., the TX resource pool 910) in which the shared COT located.

In some examples, the shared COT is less than the subchannel size selected by the first UE. In response to triggering the resource reselection, the first UE 104a selects a subchannel size less or equal than that the shared COT. Thus, in some arrangements, determining by the first UE 104a, a subchannel size smaller or equal than a subchannel size of the COT shared by the second UE 104b.

In some examples, except the COT sharing, the first UE 104a can also obtain the COT by perform LBT itself. In response to triggering the resource reselection, the first UE 104a selects a subchannel size less or equal than that the COT obtained by itself. Thus, in some arrangements, the first UE 104a itself determines a subchannel size lesser than or equal to a subchannel size of the COT obtained.

In some examples, the shared COT is within one of configured resource pools without PSFCH, and the responding UE (e.g., the first UE 104a) has to select a pool with PSFCH. In some examples, the responding UE ignores the shared COT. Thus, in some arrangements, in response to determining that the COT of the second UE 104b is within a configured resource pool without being associated with a PSFCH, the first UE 104a ignores the COT of the second UE 104b. In some arrangements, in response to determining that the COT shared by the second UE 104b is outside of a resource pool selecting, by the first UE 104a, the resource pool where the shared COT is located.

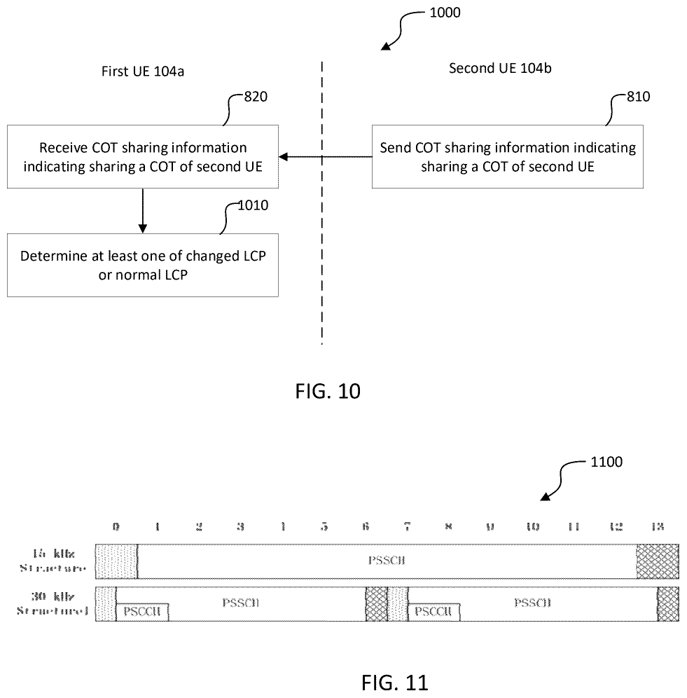

FIG. 10 is a flowchart diagram illustrating an example method 1000 for performing COT sharing, according to various arrangements. The method 1000 can be performed using the network 100 and/or the system 200. At 810, the second UE 104b sends COT sharing information to the first UE 104a, the COT sharing information indicates sharing of a COT of the second UE 104b. The second UE 104b occupies the COT corresponding to the COT of the second UE 104b in response to performing a channel access procedure (e.g., LBT) on a carrier (e.g., an unlicensed carrier). At 820, the first UE 104a receives from the second UE 104b the COT sharing information. At 1010, the first UE 104a determines at least one of a changed Logical Channel Prioritization (LCP) or a normal LCP. The changed LCP is the LCP taking use condition of shared COT into consideration, e.g., select a destination or LCH meeting the use condition of the shared COT. The use condition can be: the destination of transmission data using this shared COT is the destination sharing the COT, or the CAPC value of the transmission data is smaller or equal than the shared COT.

The legacy LCP is the normal LCP. Normal LCP is the LCP without taking the use condition of shared COT into consideration.

In some examples, the first UE 104a can select either the changed LCP to satisfy the COT requirement (and perform the type-2 LBT) or legacy or normal LCP (e.g. using type-1, type-2 LBT). For the first UE 104a that uses a shared COT for an SL grant, the shared COT (shared by the second UE 104b) is not determined based on the sensing result of the first UE 104a. The first UE 104a is configured to perform changed LCP, legacy LCP, or both. In some examples, a priority threshold is defined, where the first UE uses the changed LCP or the legacy LCP depends on whether the priority is higher than the threshold. The priority can be at least one of a CAPC value, or priority of logical channel. That is, the at least one of the changed LCP or the normal LCP is determined in response to determining that a priority (of a transmission is greater than a threshold priority (e.g., the priority/CAPC threshold).

Conventionally, a UE first selects an UL grant from a pool, and then performs LCP. Then the premise of using shared COT for LCP is that the selected grant is within the shared COT. In the examples in which the shared COT includes two RB sets, according to WiFi standards, the two RB sets need to perform joint LBT. The premise of joint LBT is that the resource selected by the responding UE covers the RB set in the shared COT. It is not possible to cover only one RB set.

In some arrangements, if the selected SL grant is within the RB set of shared COT, use changed-LCP. In other words, in some examples, the changed LCP is selected by the first UE 104a in response to determining that an SL grant is within a frequency resource of the COT of the second UE 104b.

In some arrangements, the UE may cannot transmit SL transmission and Uu transmission simultaneously. The UE will perform intra-UE prioritization including: comparing the priority of SL transmission data and Uu transmission data, and then determine the SL or Uu transmission is deprioritized. For intra-UE prioritization, if changed LCP is employed, satisfying COT requirements for the highest priority leads to de-prioritized of a transmission, whereas in normal LCP, the SL UE has the opportunity to transmit the transmission(i.e. SL transmission is not deprioritized).

In some examples, the UE 104a first ensure the highest Logical Channel (LCH) is selected, then considers destination influence of COT. That is, in some arrangements, the first UE 104a selects an LCH for the COT based on a highest priority level for the LCH, and then based on destination influence of the COT.

If changed-LCP causes different intra-UE prioritization results as compared with legacy LCP, then legacy LCP is used. In a first case, the first UE 104a determines that sensing result is not available or the selected resource is not within the shared COT, in response to which the changed LCP is used. In a second case, the first UE 104a determines that type 1 LBT cannot be used, in response to which the changed LCP is used. Accordingly, in some arrangements, the method 1000 further includes determining, by the first UE 104a, a first intra-UE prioritization result for the changed LCP, determining, by the first UE 104a, a second intra-UE prioritization result for the normal LCP, and selecting, by the first UE 104a, the normal LCP in response to determining that the first intra-UE prioritization result and the second intra-UE prioritization result are different.

In some arrangements, the first UE is a remote UE, and the second UE is a relay UE. The first UE connect with network via multiple path including direct path and indirect path. The direct path is that the remote UE connect with network directly, the indirect path is that the remote UE connect with network via relay UE. In some arrangements, a remote UE sends a resume signaling to trigger relay UE enter into RRC Connected state, and relay UE send a response signaling including resume result to remote UE. The resume result including at least one of following: indicating whether relay UE has entered into RRC Connected state, the RRC state of relay UE, resume success, resume failure.

The remote UE report the resume result to network. In one embodiment, in response to determine the relay UE does not enter into the RRC state by sending resume signaling, remote UE trigger relay UE enter into RRC connected state by sending signaling via at least one of RLC1 or RLC0.

While various arrangements of the present solution have been described above, it should be understood that they have been presented by way of example only, and not by way of limitation. Likewise, the various diagrams may depict an example architectural or configuration, which are provided to enable persons of ordinary skill in the art to understand example features and functions of the present solution. Such persons would understand, however, that the solution is not restricted to the illustrated example architectures or configurations, but can be implemented using a variety of alternative architectures and configurations. Additionally, as would be understood by persons of ordinary skill in the art, one or more features of some arrangements can be combined with one or more features of another arrangement described herein. Thus, the breadth and scope of the present disclosure should not be limited by any of the above-described illustrative arrangements.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques. To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according arrangements of the present solution.

Additionally, memory or other storage, as well as communication components, may be employed in arrangements of the present solution. It will be appreciated that, for clarity purposes, the above description has described arrangements of the present solution with reference to different functional units and processors. However, it will be apparent that any suitable distribution of functionality between different functional units, processing logic elements or domains may be used without detracting from the present solution. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed:

1. A wireless communication method, comprising:
determining, by a first wireless communication device, at least one first resource for performing sidelink (SL) communications with a second wireless communication device;
performing, by the first wireless communication device, resource reselection for the SL communications with the second wireless communication device due to a determination of Listen Before Talk (LBT) failure for the SL; and
performing, by the first wireless communication device with the second wireless communication device, the SL communications.

2. The method of claim 1, wherein the SL communications comprises a Synchronization Signal Block (SSB) transmission, wherein the resource reselection is performed in response to the first wireless communication device determining LBT failure for the SSB transmission, and wherein a frequency resource used to transmit the SSB transmission is within a transmission frequency resource pool of the first wireless communication device.

3. The method of claim 1, wherein the SL communications comprises a Physical Sidelink Feedback Channel (PSFCH) transmission, wherein the resource reselection is performed in response to the first wireless communication device determining LBT failure for the PSFCH transmission, and wherein a frequency resource used to transmit the PSFCH transmission is within a transmission frequency resource pool of the first wireless communication device.

4. The method of claim 1, wherein the at least one first resource comprises a plurality of first resources, and wherein the determining the at least one first resource for performing the SL communications with the second wireless communication device comprises:
determining, by the first wireless communication device, a Hybrid Automatic Repeat Request (HARQ) retransmission number; and
determining, by the first wireless communication device, a number of the plurality of first resources based on the HARQ retransmission number.

5. The method of claim 4, wherein the performing the SL communications comprises increasing a count indicated by a counter in response to retransmitting, by the first wireless communication device to the second wireless communication device, a first transmission.

6. The method of claim 5, comprising dropping at least one remaining resource of the plurality of first resources in response to determining that the count reaches the HARQ retransmission number, wherein the at least one remaining resource remains unused for retransmitting the first transmission.

7. The method of claim 5, comprising using at least one remaining resource of the plurality of first resources to transmit a second transmission in response to determining that the count reaches the HARQ retransmission number, wherein the at least one remaining resource remains unused for retransmitting the first transmission.

8. The method of claim 1, wherein the SL communications is performed using a first module and a second module, wherein the method comprises determining that at least one of a first overlapping resource or one or more subsequent resources of the second module is overlapping with one time resource of the first module, and wherein the first overlapping resource and a subsequent resource are overlapping with a same resource of the first module.

9. The method of claim 8, wherein the at least one first resource is determined by the first wireless communication device in response to determining at least one of:
the at least one first resource is a first overlapping resource that overlaps with a time resource of the first module; or
the at least one first resource is a subsequent overlapping resource that overlaps with the resource of the first module, and a corresponding first overlapping time resource is selected that overlaps with the resource of the first module.

10. The method of claim 8, comprising determining the at least one first resource is a subsequent overlapping resource, and the first wireless communication device does not transmit a transmission on the first overlapping resource.

11. A wireless communication method, comprising:
receiving, by a first wireless communication device from a second wireless communication device, Channel Occupy Time (COT) sharing information indicating sharing a COT of the second wireless communication device;
determining, by the first wireless communication device, at least one resource; and
determining, by the first wireless communication device, at least one of a changed Logical Channel Prioritization (LCP) or a normal LCP.

12. The method of claim 11, wherein the at least one of the changed LCP or the normal LCP is determined in response to determining that a priority of a transmission is greater than a priority threshold.

13. The method of claim 11, wherein the changed LCP is selected in response to determining that an SL grant is within a frequency resource of the COT of the second wireless communication device.

14. The method of claim 11, comprising selecting a Logical Channel (LCH) for the COT based on a highest priority level for the LCH, and then based on destination influence of the COT.

15. The method of claim 11, comprising:
determining, by the first wireless communication device, a first intra-UE prioritization result for the changed LCP;
determining, by the first wireless communication device, a second intra-UE prioritization result for the legal LCP; and
selecting, by the first wireless communication device, the legal LCP in response to determining that the first intra-UE prioritization result and the second intra-UE prioritization result are different.

16. The method of claim 11, comprising transmitting, by the first wireless communication device to the second wireless communication device, COT assistance information for a desired COT, the COT assistance information comprising at least one of:
a timing slot;
a Resource Block (RB) index;
a resource pool index;
a number of RB sets; or
a subchannel size.

17. The method of claim 11, wherein determining the at least one resource for the COT comprises selecting, by the first wireless communication device, a resource having a subchannel size smaller than a subchannel size of the COT of the second wireless communication device.

18. The method of claim 11, comprising in response to determining that the COT of the second wireless communication device is within a configured resource pool without being associated with a Physical Sidelink Feedback Channel (PSFCH), ignoring, by the first wireless communication device, the COT of the second wireless communication device.

19. The method of claim 11, comprising in response to determining that the COT of the second wireless communication device is outside of a resource pool, selecting, by the first wireless communication device, the resource pool.

20. A wireless communication apparatus comprising at least one processor and a memory, wherein the at least one processor is configured to read code from the memory and cause the wireless communication apparatus to implement a method comprising:
determining at least one first resource for performing sidelink (SL) communications with a second wireless communication device;
performing resource reselection for the SL communications with the second wireless communication device due to a determination of Listen Before Talk (LBT) failure for the SL; and
performing the SL communications with the second wireless communication device.
